(19) United States
(12) Patent Application Publication
(10) Pub. No.: US 2026/0159287 A1
(43) Pub. Date: Jun. 11, 2026

(54) HEAT-OPERATED, DYNAMIC COVER, LID OR CONTAINER

(71) Applicant: Doris Sung, Rolling Hills, CA (US)

(72) Inventor: Doris Sung, Rolling Hills, CA (US)

(21) Appl. No.: 18/972,729

(22) Filed: Dec. 6, 2024

(51) Int. Cl. B65D 51/00; F21V 35/00

(52) U.S. Cl. CPC B65D 51/00; F21V 35/00

(57) ABSTRACT

A top or lid of a container housing is formed of thermobimetal or any bi-materials whereby heat from an internal heat source(s) or from an overhead heat source, when lit or producing heat, causes members of the bi-material top to curl thereby creating an opening and exposing the interior therein. The housing is configured to contain one or more internal heat sources. The housing may or may not have a bottom. With no bottom, the housing is configured to be placed over a heat source such as a resting candle. With a bottom, the bottom may be configured to open and close allowing the heat source to be placed therein. Alternatively, one or more sides of the housing may include a method of access to the interior cavity to access the heat source. An alternative heat source from above and external to the housing, such as a lamp or the sun, can also activate the biomaterial top or lid.

### FIELD OF THE INVENTION

The embodiments of the present invention relate generally to a dynamic cover, lid or container operated using an internal or external heat source, such as a candle or heat lamp.

### BACKGROUND

Bi-material including, thermobimetal (aka thermostatic metal, thermal bimetal, bimetal, etc.), is a composite material comprising two materials of any appropriate nature, metallic or otherwise, which, due to the differing expansivities of the materials, tends to alter its curvature when its temperature is changed. Such materials can be used to generate movement for a variety of purposes, including the operation of aesthetically pleasing articles.

Thus, it would be advantageous to develop a dynamic cover, lid or container operated using heat from an internal heat source (e.g., candle) or an external heat source from above. It would be further advantageous if the dynamic cover, lid or container was aesthetically pleasing.

### SUMMARY

The embodiments of the present invention include a housing configured, in one embodiment, to contain a heat source such as one or more candles. The housing may or may not have a bottom. An embodiment with no bottom, is configured to be placed over the heat source such as one or more candles where they are resting. In an embodiment with a bottom, the bottom may be configured to open and close allowing the heat source to be placed therein. Alternatively, one or more sides of the housing may include a door allowing the heat source to be placed therein. A top or lid of the housing is formed of bi-material whereby heat from inside or above causes the bi-material top to move thereby opening the top and exposing the contents inside.

In one embodiment, the housing is shaped like a box and the top comprises four bi-material flaps, which, when heated, move upwardly to expose the contents inside. In another embodiment, the housing is cylindrical, and the top is formed of series of petal-shaped bi-material sections, which, when heated, curve upwardly to expose the contents inside. The embodiments of the present invention can be facilitated by housings and corresponding tops of countless designs and shapes.

While conventional candles are detailed as one heat source herein, it is apparent that other heat sources may be used to operate the embodiments of the present invention. For example, incandescent bulbs, heat lamps, chaffing fuel, charcoal, the sun, etc. may be used. The heat sources may be internal or external to the housing.

Other variations, embodiments and features of the present invention will become evident from the following detailed description, drawings and claims.

### BRIEF DESCRIPTION OF THE DRAWINGS

FIG. 1A illustrates an upper perspective view of a first container housing with a closed lid according to the embodiments of the present invention;

FIG. 1B an upper perspective view of the first container housing of FIG. 1A with the lid open according to the embodiments of the present invention;

FIG. 2A illustrates an upper perspective view of a second container housing with a closed lid according to the embodiments of the present invention;

FIG. 2B an upper perspective view of the second container housing of FIG. 2A with the lid open according to the embodiments of the present invention;

FIG. 3A illustrates an upper perspective view of a third container housing with a closed lid according to the embodiments of the present invention;

FIG. 3B illustrates an upper perspective view of the third container housing of FIG. 3A with the lid partially open according to the embodiments of the present invention;

FIG. 3C illustrates an upper perspective view of the third container housing of FIG. 3A with the lid fully open according to the embodiments of the present invention;

FIG. 4A illustrates an upper perspective view of a fourth container housing with a closed lid according to the embodiments of the present invention;

FIG. 4B illustrates an upper perspective view of the fourth container housing of FIG. 4A with the lid partially open according to the embodiments of the present invention;

FIG. 4C illustrates an upper perspective view of the fourth container housing of FIG. 4A with the lid fully open according to the embodiments of the present invention;

FIG. 5A illustrates an upper perspective view of the fifth container housing with a closed lid according to the embodiments of the present invention;

FIG. 5B illustrates an upper perspective view of the fifth container housing of FIG. 5A with the lid open according to the embodiments of the present invention;

FIG. 6 illustrates a container housing with a first bottom partially open according to the embodiments of the present invention;

FIG. 7 illustrates a container housing with a second bottom partially open according to the embodiments of the present invention;

FIG. 8A illustrates a side view of a container housing of FIG. 6A with a door closed according to the embodiments of the present invention;

FIG. 8B illustrates a side view of the container housing of FIG. 6A with the door open according to the embodiments of the present invention; and

FIG. 9 illustrates a side view of the container housing of FIG. 1B with the lid open based on an overhead heat source such as a lamp or the sun according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

In broad terms, the embodiments of the present invention include a housing configured to contain one or more heating elements. An internal or external heat source causes the container to open. A top or lid of the housing is formed of bi-material like thermobimetal whereby heat from one or more candles, for example, when lit, causes the bi-material top to move thereby opening the top and exposing the one or more candles therein. The embodiments of the present invention can be facilitated by using housings and corresponding tops of countless designs, as detailed below, for practical, functional and aesthetic reasons. Those skilled in the art will recognize that while the certain embodiments focus on thermobimetals and a heat source in the form of a candle, any suitable bi-material may be used and the heat source may take on any suitable form internal or external to the housing.

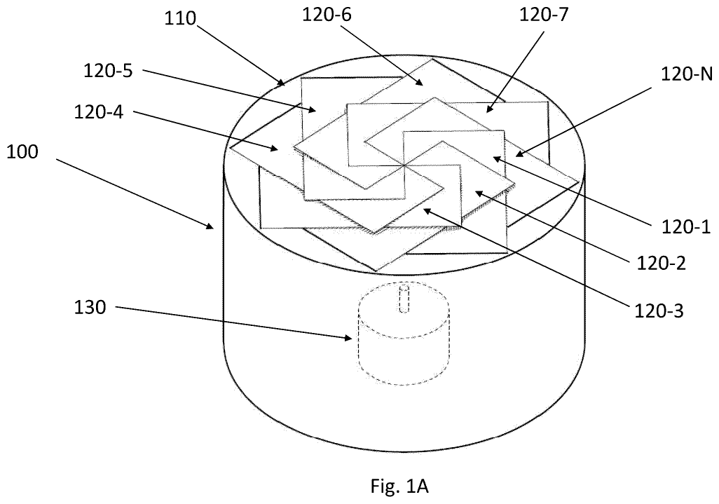

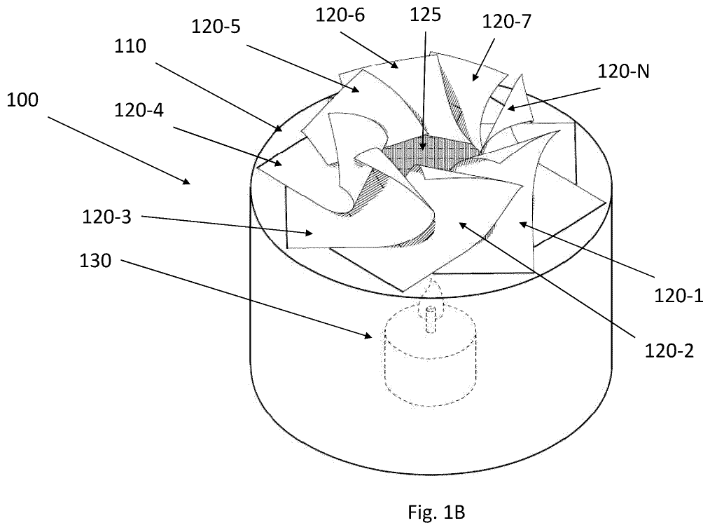

FIGS. 1A and 1B illustrate an upper perspective view of a first container housing 100. The container housing 100 may be fabricated of any suitable material including metals, rubber, plastic, alloys, etc. Ideally, the container housing 100 is fabricated of an insulative material so as not to conduct heat generated by the heat source. As shown, the first container housing 100 is cylindrical in shape. In this embodiment, a top 110 of the first container housing 100 comprises a series of individual rectangular panels 120-1 through 120-N. The panels 120-1 through 120-N are at least partially made of bi-material such as a thermobimetal such that the panels 120-1 through 120-N react to heat generated by heat source 130. As shown in FIG. 1B, portions of the panels 120-1 through 120-N react by curling or bending upwards to create an opening 125 exposing the internal portions of the container housing 100 allowing heat to escape.

Because bi-materials including thermobimetal react to heat, pairing the material with an open flame allows it to operate quickly and swiftly. Bi-materials including thermobimetals are a smart material that reacts to temperature changes by curling. When positioned, for example, above the flame of a candle or in the rays of the sun, the material curls and activates a variety of mechanical movements including cantilevering, pivoting, rotating, bending, etc.

In one embodiment, the bi-material panels 120-1 through 120-N are approximately 0.03″ thick such that the bi-material panels 120-1 through 120-N do not retain enough heat to burn the user upon touch. In another embodiments, the bi-material panels 120-1 through 120-N may be thinner or thicker than 0.03″.

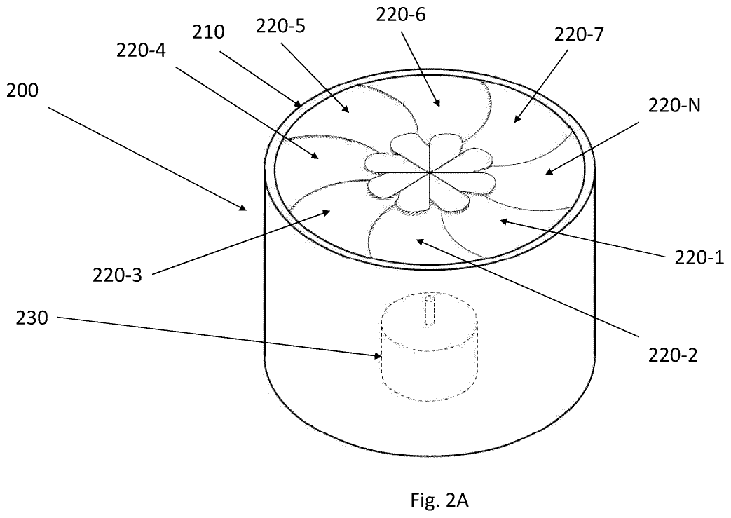

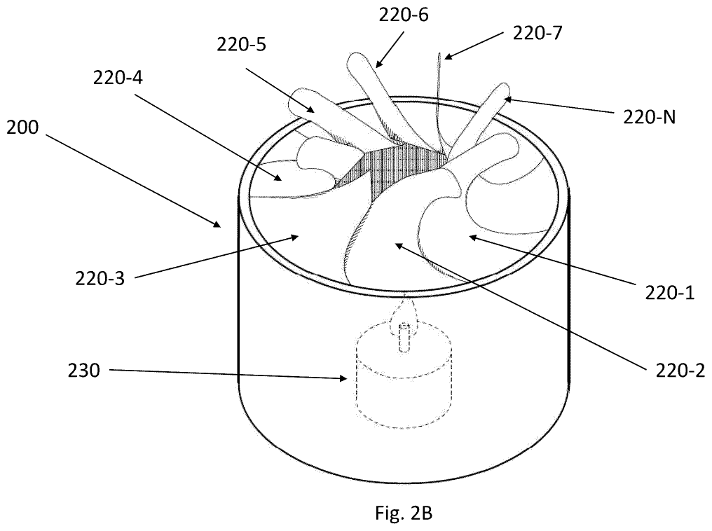

FIGS. 2A and 2B illustrate an upper perspective view of a second container housing 200. As shown, the second container housing 200 is cylindrical in shape. In this embodiment, a top 210 of the second container housing 200 comprises a series of individual polygonal panels 220-1 through 220-N. The panels 220-1 through 220-N are at least partially made of bi-material such that the panels 220-1 through 220-N react to heat generated by the heat source 230. As shown in FIG. 2B, portions of the panels 220-1 through 220-N react by curling or bending upwards to create an opening 225 exposing the internal portions of the container housing 200 allowing heat to escape.

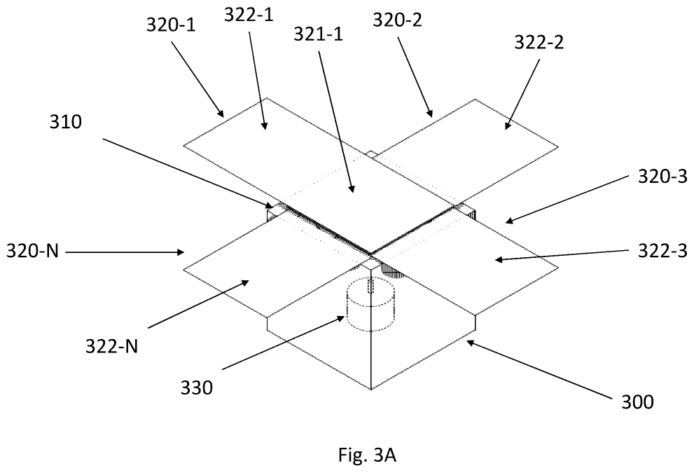

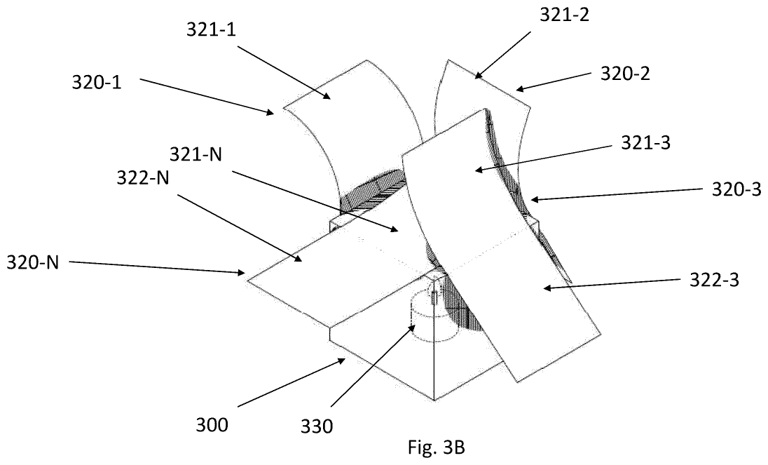

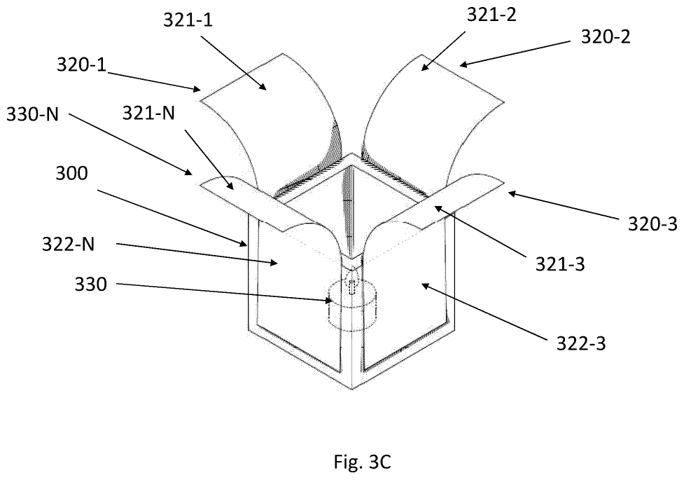

FIGS. 3A through 3C illustrate an upper perspective view of a third container housing 300. As shown, the third container housing 300 is a cube. In this embodiment, a top 310 of the third container housing 300 comprises a series of individual flaps 320-1 through 320-N. The flaps 320-1 through 320-N are attached at any point on the upper edges of the container housing 300. Portions of the flaps 320-1 through 320-N are at least partially made of bi-material such that the flaps 320-1 through 320-N react to heat generated by the heat source 330. As shown in FIGS. 3B and 3C, portions of the panels 320-1 through 320-N react by curling or bending upwards to create an opening 325 exposing the internal portions of the container housing 300 allowing heat to escape.

As shown in FIGS. 3A through 3C, the flaps 320-1 through 320-N are rectangular whereby a first section 321-1 through 321-N serves to cover a top opening and a second section 322-1 through 322-N extends beyond the top opening and when open, abuts a side of the housing 300. As heat is applied, the first section 321-1 through 321-N curl causing the flaps 320-1 through 320-N to rotate about the mid-points about the upper edges of the top.

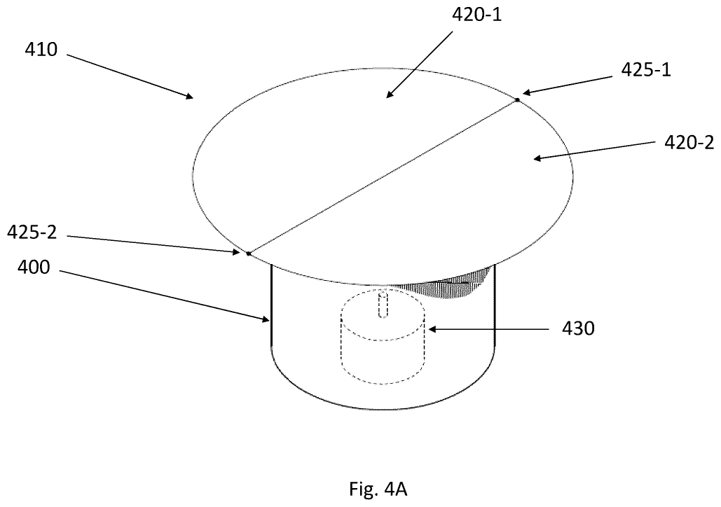

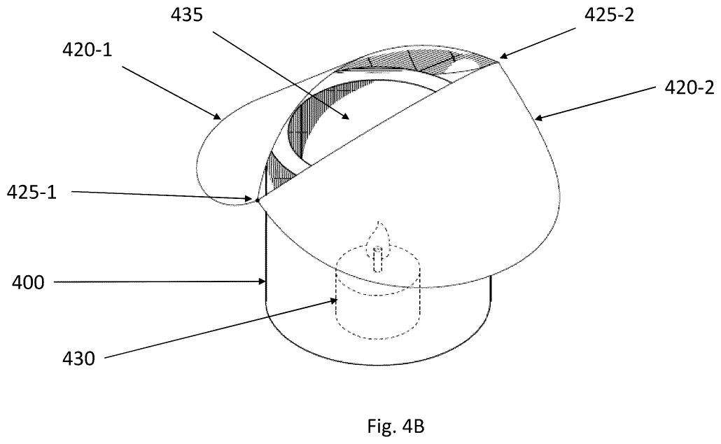

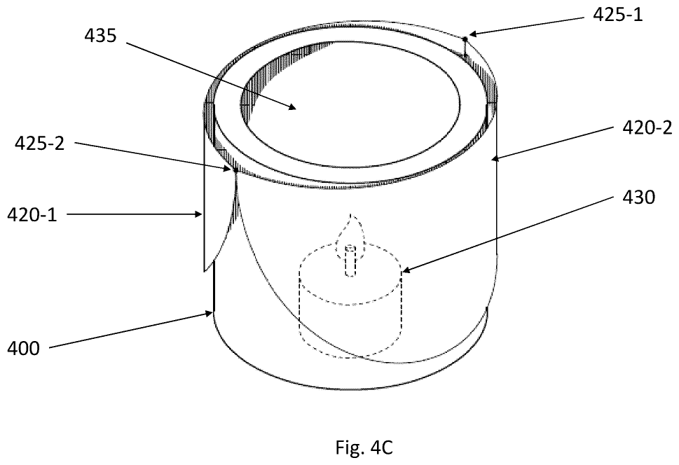

FIGS. 4A through 4C illustrate an upper perspective view of a fourth container housing 400. As shown, the fourth container housing 400 is cylindrical in shape. In this embodiment, a top 410 of the fourth container housing 400 comprises a pair of semi-circular members 420-1, 420-2. The semi-circular members 420-1, 420-2 are hinged at points 425-1, 425-2 at ends of a diameter line. Portions of the semi-circular members 420-1, 420-2 are at least partially made of bi-material such that the semi-circular members 420-1, 420-2 react to heat generated by the heat source 430. As shown in FIGS. 4B and 4C, portions of the semi-circular members 425-1, 425-2 react by curling or bending thus moving apart, about the points 425-1, 425-2, creating opening 435 exposing the internal portions of the container housing 400 allowing heat to escape.

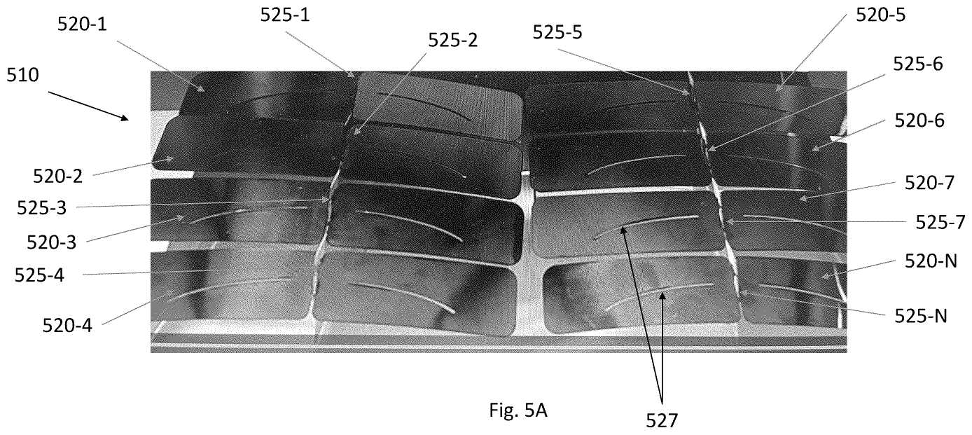

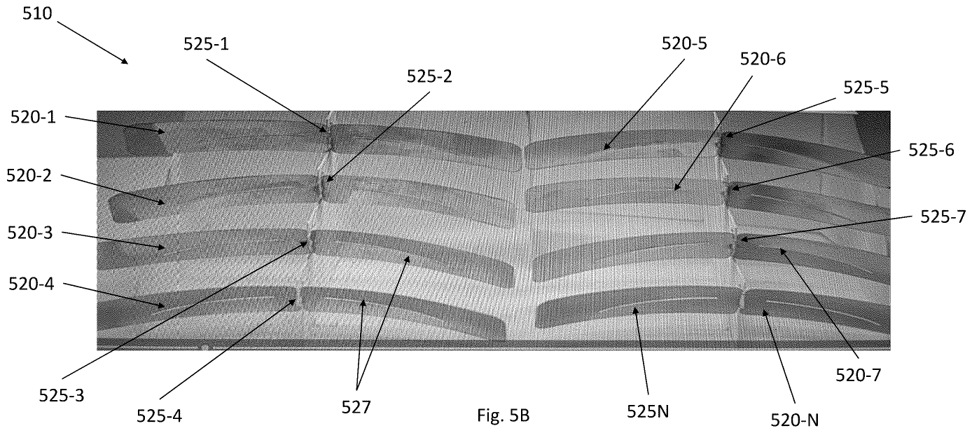

FIGS. 5A and 5B illustrate top down views of a top 510 for a container housing (not shown). In this embodiment, the top 510 comprises a plurality of rectangular panels 520-1 through 520-N. The rectangular panels 520-1 through 520-N are hinged at mid-points 525-1 through 525-N. Portions of the rectangular panels 520-1 through 520-N are at least partially made of bi-material such that the rectangular panels 520-1 through 520-N react to heat generated by flames from a candle or other heat source. As shown in FIGS. 5A and 5B, portions of the rectangular panels 520-1 through 520-N react by curling or bending thus rotating approximately 90°, about the mid-points 525-1 through 525-N, creating an opening exposing the internal portions of the container housing allowing heat to escape. To promote the proper curling or bending, the rectangular panels 520-1 through 520-N may include slits 527.

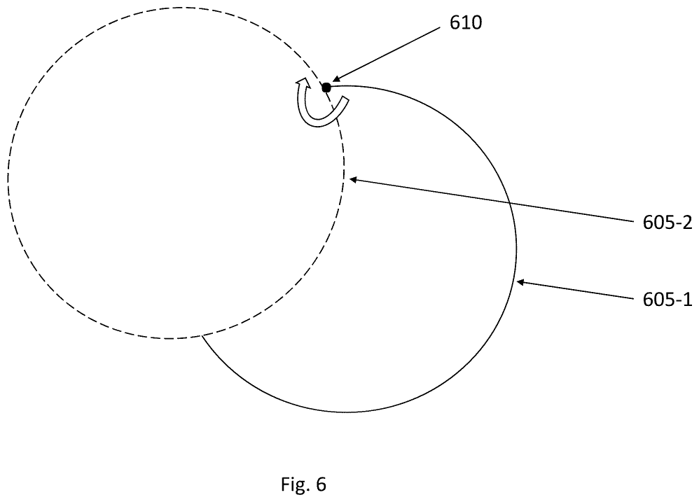

Certain embodiments of the present invention may include housing with a bottom that may open and close to permit the insertion of one or more candles or other heat sources into the container. FIG. 6 shows one such bottom 605-1 (closed) and 605-2 (open) which opens and closes (i.e., rotates) about a hinge 610. In the open position, the heat source can be placed on an upper surface of the bottom before the bottom is closed.

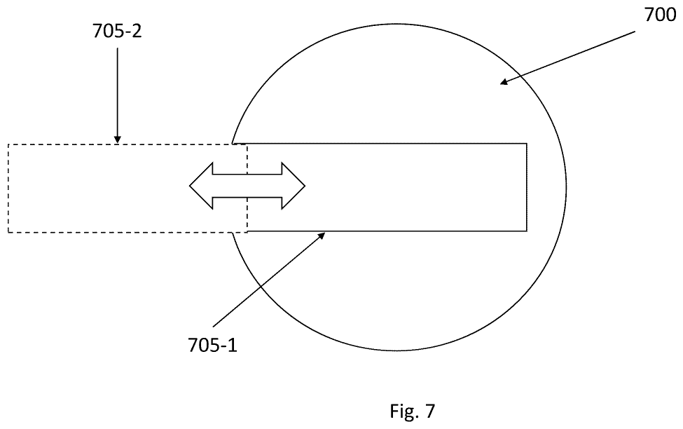

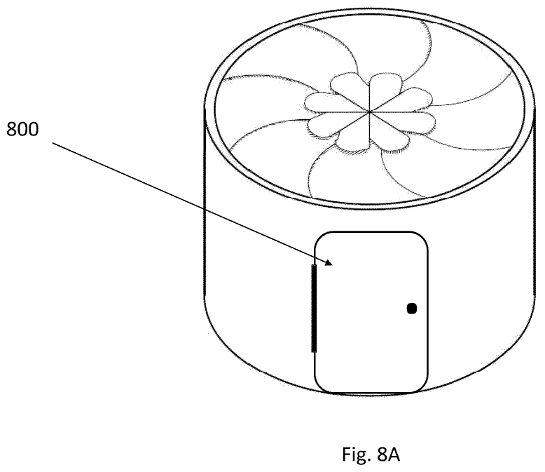

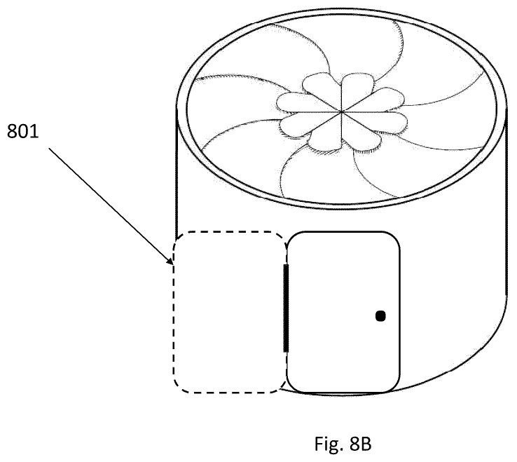

FIG. 7 shows a second embodiment of a container bottom 700 with a slider 705-1 (closed) and 705-2 (open). FIG. 8A shows a door 800 (closed) and FIG. 8B shows the door 801 (open) which may provide access to position a heat source or one or more candles therein.

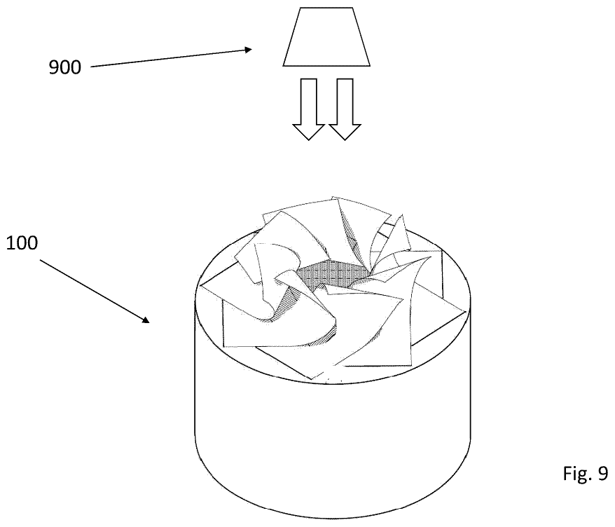

FIG. 9 shows the housing 100 of FIGS. 1A and 1B subjected to an overhead light source 900 (e.g., heat lamp or the rays of the sun). As with the one or more candles being placed within the candle container housing 100, the overhead heat source 900 causes the panels 120-1 through 120-N to curl or bend.

While candles are discussed herein, it is reiterated that any heat source may be used to cause the bi-materials (e.g., thermobimetal) portions of the top of the container to curl and bend. Using various hinge points and designs, the tops curl and bend to create an opening.

Although the invention has been described in detail with reference to several embodiments, additional variations and modifications exist within the scope and spirit of the invention as described and defined in the following claims.

I claim:

1. A heat triggered container comprising:
a housing;
a top, said top comprising of one or more members, said one or more members fabricated, at least partially, of a bi-material; and
wherein said one or more members are arranged such that application of heat causes, at least portions of, said one or more members to curl thereby creating an opening in said top.

2. The heat triggered container of claim 1 wherein heat is applied by one or more lit candles within said housing.

3. The heat triggered container of claim 1 wherein heat is applied by an overhead heat source.

4. The heat triggered container of claim 1 further comprising a bottom or can be bottomless.

5. The heat triggered container of claim 4 wherein said bottom includes access to an internal portion of said container.

6. The heat triggered container of claim 1 wherein said housing includes access to an internal portion of said container.

7. The heat triggered container of claim 1 wherein said one or more members are 0.03″ thick.

8. The heat triggered container of claim 1 wherein said bi-material is a thermobimetal.

9. A heat triggered container comprising:
a housing with a top, said top comprising a plurality of members fabricated of bi-material; and
wherein said plurality of members are arranged such that application of heat causes, at least portions, of each of said plurality of members to curl thereby creating an opening in said top.

10. The heat triggered container of claim 9 wherein heat is applied by a heat sources such as one or more lit candles within said housing.

11. The heat triggered container of claim 9 wherein heat is applied by an overhead heat source.

12. The heat triggered container of claim 9 further comprising a bottom or can be bottomless.

13. The heat triggered container of claim 12 wherein said bottom includes access to an internal portion of said container.

14. The heat triggered container of claim 9 wherein said housing includes access to an internal portion of said container.

15. The heat triggered container of claim 9 wherein said plurality of members are 0.03″ thick.

16. The heat triggered container of claim 9 wherein said bi-material is a thermobimetal.

17. A system comprising:
a heat source;
a container comprising:
a housing with a top, said top comprising a plurality of members fabricated of bi-material; and
wherein said plurality of members are arranged such that application of heat, via said heat source, causes, at least portions, of each of said plurality of members to curl thereby creating an opening in said top.

18. The heat triggered container of claim 17 wherein heat is applied by one or more lit candles within said housing.

19. The heat triggered container of claim 17 wherein heat is applied by an overhead heat source.

20. The heat triggered container of claim 17 further comprising a bottom.

21. The heat triggered container of claim 20 wherein said bottom includes access to an internal portion of said container.

22. The heat triggered container of claim 17 wherein said housing includes access to an internal portion of said container.

23. The heat triggered container of claim 17 wherein said plurality of members are 0.03″ thick.

24. The heat triggered container of claim 1 wherein said bi-material is a thermobimetal.
